(19) United States
(12) Patent Application Publication
(10) Pub. No.: US 2007/0075167 A1
(43) Pub. Date: Apr. 5, 2007

(54) Method for industrial producing of highly dispersed powders

(76) Inventors: Jouko Niemi, Pirkkala (FI); Jarkko Tamminen, Tampere (FI)

Correspondence Address: STITES & HARBISON PLLC, 1199 NORTH FAIRFAX STREET, SUITE 900, ALEXANDRIA, VA, 22314, US

(21) Appl. No.: 10/574,957

(22) PCT Filed: Oct. 10, 2003
(86) PCT No.: PCT/FI03/00750

§ 371 Date: Apr. 7, 2006

(51) Int. Cl. B02C 19/06

(52) U.S. Cl. 241/5

(57) ABSTRACT

This invention relates to industrial production of fine dispersed powders, where the material to be pulverized is mixed with high-pressure working into a gas-solids suspension, which through acceleration nozzles (8) is conveyed to the pulverizing chamber of counterjet pulverizer (9) for autogenous pulverization. The method is known in that the pulverized gas solids suspension is conveyed in the pulverizing circle at least to one intermediate tank (12), where the gas is removed from the blend and solids are collected into intermediate tank (12), which are returned together with new raw material for pulverization till in the equipment a wanted circulation load is achieved, whereafter the process continues so that from it as much ready product is removed as new material is added to it.

This invention relates to a method according to the preamble of individual claim 1, by means of which it possible to produce for the processing industry necessary powders and coating agents and pigments finer as before most economically, effectively and solid.

Currently, micronizing methods of different types based on the 1-phase principle are in general use, by means of which methods solid powders and coating agents and pigments necessary for the processing industry are produced. In devices based on the 1-phase principle as pulverizing energy high pressure energetic working gas, compressed air, steam or some shielding gas is used.

As essential part of the micronizing device based on the 1-phase technique there is often also a built-in pneumatic classifier often furnished with a mechanical rotor. Generally, processes working by 1-phase principle function so that the material to be pulverized is fed to the process in a stage, where in separate gas nozzles accelerated kinetic energy is developed into corpuscles/particles to be pulverized, for instance by means of mere 9 bar or even 16 bar working gas, resulting in that they become pulverized to some extent. Clearly the kinetic energy generated in the particles, regardless of high pressure and energetic working gas, remains quite small and the pulverizing effect poor. It is especially difficult to produce products by 1-phase technique, where especially corpuscles, the size of which is within the range 0.2-5 microns for instance of industrial minerals. Then the consumption/cost of energy increases quite strongly and the production capacity of the equipment drops.

The operation conditions of a functioning pulverizing method working by the 1-phase principle get worse, since while the size of the particles is getting smaller the classification of particles using a rotor-furnished pneumatic classifier becomes quite difficult, because as a mass the particles under 5 microns behave almost like gas.

Devices working by 1-phase flow are often so built that pulverizing and classification take place in the same place and are linked together also through the volume of gas. This is not good, since a small change in either partial process may have a harmful effect on the other part of the process. Restrictions of this type in present devices based on the 1-phase principle powerfully restrict the possibilities to produce for the industry necessary solid end products and to their average fineness 0.2-5.0 microns economically and effectively.

The intention of this invention is elimination of the above presented disadvantages, which is accomplished by means the method according to the characterizing part of individual claim 1 of this invention.

The other characteristics of this invention are disclosed in the dependent claims.

According to the method of this invention the material to be pulverized is fed by a double-valve feeder to a counterjet pulverizer. In the intermediate tank of the double-valve feeder feed pressure higher than the real pulverizing pressure is used. The flow of working gas of the counterjet pulverizer is cut off or choked for a short time, when the lower valve of the double-valve feeder is opened. This measure ensures effective travel of material with low bulk density to the balancing tank of the counterjet pulverizer, in the end part of which the wanted gas-solids suspension is generated from material and energetic working gas. Material pulverizing takes place, depending on the matter, by means of economically developed working gas of 1-8 bar pressure. The generated gas-solids suspension makes it possible to utilize the 2-phase flow effectively.

The kinetic energy contained in the gas-solids suspension can be used and utilized in different pulverizing chamber units effectively in a small space, where also small particles are in the sphere of influence of high-energy particles in a controllable way. This takes space using in the pulverizing chambers acceleration nozzles of different types as nozzles in another unit acceleration nozzles furnished with gas outlet holes. Then the units produce as to their granulate distribution different kinds of products, in other words restrict the production of some particle sizes.

Products pulverized in separate pulverizing units can be kept separated or joined and stored in an intermediate tank built in one or several pulverizing spheres of influence. The function of intermediate storing is to control by means of mass-monitoring the volume of circulation load. In this case, producing autogenously ultra fine 0.2-5 micron particles requires in the pulverizing circle a great circulation load and it is wise to build the volume needed by the circulation load outside the normal pulverizing equipment.

The bulk density of material momentary stored in the intermediate tank but being in circulation rises, which facilitates its effective backfeed to the counterjet pulverizer.

From the intermediate tank or tanks removal of material is also started as end product after the wanted circulation load quantity is generated in the pulverizing circle. Since all material that is to be pulverized moves through the pulverizing chambers of the counterjet pulverizer the particles to be pulverized stay in the pulverizing process min. for 1 pulverizing circulation and max. for as long as chosen circulations, for instance 7 circulations. The intermediate tank or tanks are so dimensioned that the circulation load can be even quite big and have a weighing system, which is part of the process control. In the above case, for instance, the intermediate tank must have room for material as much as 7× feed quantity.

Of course the quantity of the removing end product is the same as the quantity of new material to be fed into the pulverizer. The use of an intermediate tank enables controllable circulation of the material and makes it also possible that important, especially of solid minerals with difficulty produced particles in the size of 0.2-5.0 microns can be effectively produced in greater quantity using by pulverizing a necessary amount of pulverizing circulations and as to their geometry different acceleration nozzles.

Material to be returned from the intermediate tank to the counterjet pulverizer is often, depending on the matter, very light as to its bulk density, which can be even under 100 kg/m³. Therefore it is worse to compress the material in a separate pressing screw conveyor before feeding into the counterjet pulverizer. Increase of the bulk density improves the material handling significantly.

If the end product must be highly dispersed and in spite of the screw compression the bulk density of material circulating in closed circuit lessens it is possible to use in connection with the counterjet pulverizer two double-valve feeder. Then the gas consumption to be used can almost be halved in utilizing the removable gas for initial pressurization of the tank of the other feeder.

The material to be taken as end product from the intermediate tank can, if necessary, be handled by a separate mechanical classifier outside the pulverizing circle, the operating principle of which is not based on gas flows and the gas is not a factor controlling the operation. With such a classificating device largest particles can be controllably separated from the end product and returned together with the circulating load to the counterjet pulverizer. Coarse product separated by the classifier can be transported into the intermediate tank as a pneumatic transfer, and as transport air pressurized air releasable can be used releasable after initial pressurization, from the double-valve feeder of the intermediate tank.

Of uniform raw material, i.e. material advantageously prepulverized in a mechanical pulverizer, an end product of unchangeable quality can be easily produced. In this manner it is possible to put pulverizing according to this invention into practice so that the share of product of necessary granular class 0.2-5 Φm increases. During circulation also the coarser granular classes reduce. Therefore no reclassification is needed. In order to ensure uniform raw material a control unit can be connected to the equipment, into which unit the limit values of most important factors connected to the micronizing process are programmed, such as
quantity of raw material per time unit,
quantity of end product per time unit,
quantity of working gas per time unit, and its pressure and temperature.
quantity of energy used for working gas pressurization
quantity of circulation load gas per time unit

Since the critical parts of the pulverizing unit retain their form for thousands of operation hours, by means of certain limit values a good quality product with unchangeable form can be produced. If a deviation occurs in the limit values, the process is interrupted and the failure corrected. This simple system facilitates the use of the process and the quality control of the end product.

In the following the invention is disclosed with reference to the enclosed drawings, where

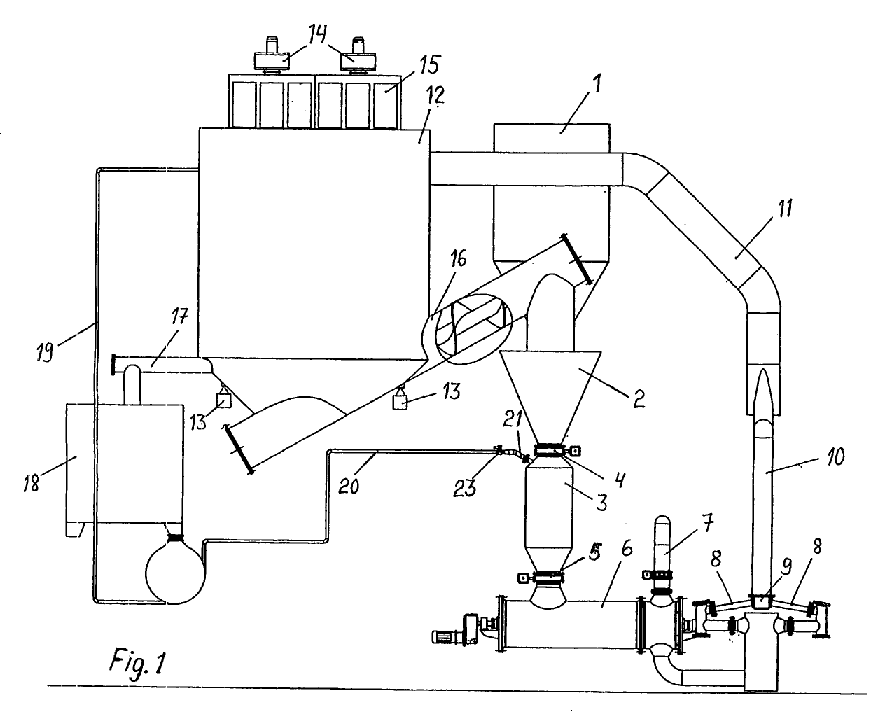

FIG. 1 shows an example as a side view of an equipment used for utilization of the method according to the invention and

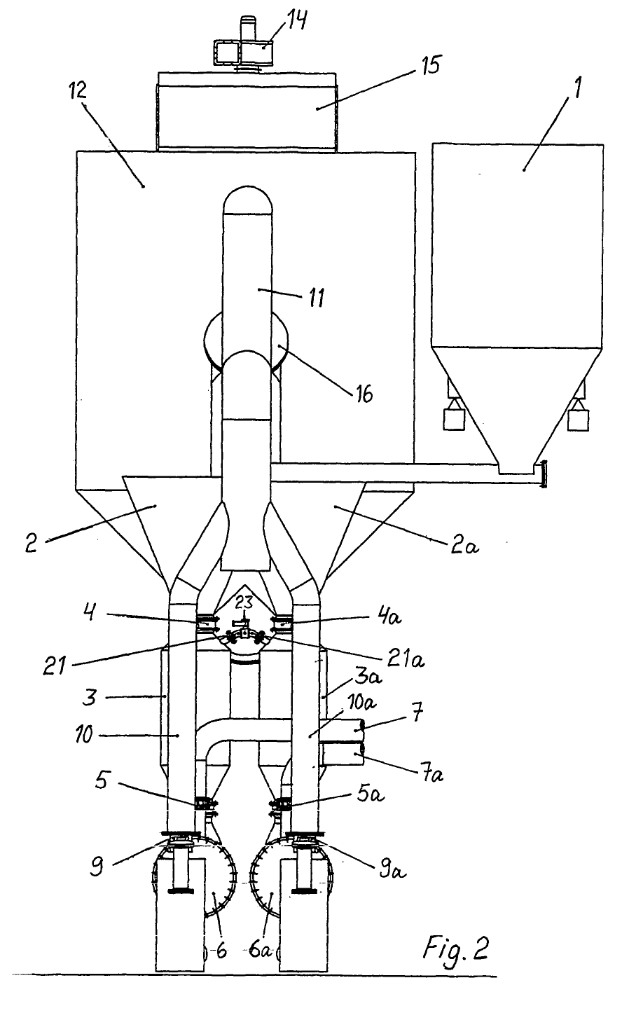

FIG. 2 shows the equipment as per FIG. 1 from the right side.

Material to be pulverized or possibly pre-pulverized in a mechanical pulverizer according to the invention is fed from feed tank 1 to feed hopper 2 of double-valve feeder, from where it is let step-by-step to intermediate tank 3 of double-valve feeder, when the tank upper valve 4 has opened. After receiving the batch of material upper valve 4 is closed and the intermediate tank is pressurized, for instance to a pressure of 5 bar, whereafter lower valve 5 of double-valve feeder is opened and the pressurized batch of material is by means of excess pressure forced to balancing tank 6, into which feed of working gas from tube 7 is broken or choked for a while in order to facilitate the transfer of light material. Then lower valve 5 is closed again, after which the pressure of intermediate tank 3 is let to the level of environment pressure conveying the pressurized gas in it somewhere through tube 21. Then upper valve 4 is opened for a new batch of material from feed hopper 2. Material pulverized in balancing tank 6 is then mixed with working gas, for instance pressurized in 3.5 bar pressure, into gas-solids suspension. From balancing tank 6 the gas-solids suspension is accelerated by the effect of working gas pressure through acceleration nozzles 8 of counterjet pulverizer 9 to the pulverizing chamber, where the material particles are autogenously pulverized on colliding with high speed. Gas-solids suspension pulverized in counterjet pulverizer 9 is conveyed through tubes 10 and 11 to large-sized stock 12 furnished with weighing system 13 for control of the collected material quality. Namely, in intermediate depot such a quantity of solids must be collected that in the system there is a sufficient circulation load in order to achieve a wanted end product, which sufficient circulation load must be maintained all the time during pulverizing process. Air is removed from intermediate tank 12 by means of suitable nozzles 14, which prevent the access of small material particles to open air. Solids collected into intermediate tank 12 tighten a little, which improves the handling of them, when returned to for pulverizing together with new material. When aimed high dispersed product, the bulk density of which is low, the bulk density of material collected into intermediate tank 12 can still be raised by means of pressing screw conveyor 16. Circulation of solids through the pulverizing equipment together with new raw material fed from feed tank 1 continues till in the equipment the target load is reached. Then the process is continued so that from feed tank 1 as much new raw material is fed, which is pulverized together with solids circulated from stock 12, as ready-made material is removed from intermediate tank 12 through exhaust tube 17. This product can be used either as such or in some cases conveyed to mechanical classifier 18 outside the pulverizing circle, where the greatest particles are separated from the end product. This separated coarse product is returned to intermediate tank 12 along tube 19 for additional pulverizing. For return of the coarse product pressurized gas releasable from intermediate tank 3 of double-valve feeder can be used after initial pressurizing which gas is conveyed along tube 20 to collection pocket of classifier 18.

According to an advisable embodiment there are in the equipment side by side two counterjet pulverizers 9,9a with own feed devices 2,2a; 3,3a; 4,4a; 5,5a; 6,6a; 7,7a, which is an advantage, for instance when the pulp density of material to be pulverized is low. Then it is advisable that the one counterjet pulverizer 9 is furnished with conventional acceleration nozzles 8 and the other counterjet pulverizer 9a is furnished with acceleration nozzles furnished with gas outlet channels, whereby also the pulverizing chamber itself is shaped otherwise than presented in Finnish patent application 20020531. By means of this new type pulverizer the pulverizing conditions can most effectively be regulated so that the end product of a wanted granule class is easily achieved.

Then both the double-feed pulverizers can advantageously be synchronized so that when a material batch has been supplied the after-pressure left in tank 3 of one double-feed pulverizer can be made use of through tubes 21 and 21a as initial pressure of tank 3a of the other double feed pulverizer after receipt of a new material batch when valves 23 in tube 20 is kept closed. Then the gas consumption in connection with feeding gets almost halved.

1. A method for industrial production of high dispersed powders, where material to be pulverized is mixed with high pressure working gas into a gas-solids suspension, which is through acceleration nozzles conveyed to the pulverizing chamber of counterjet pulverizer for autogenic pulverizing, characterized in that the pulverized gas-solids suspension is conveyed at least to one intermediate tank in the pulverizing circle, where the gas is removed from the blend and solids collected into intermediate tank, which are returned to be pulverized together with new raw material till there is in the equipment a wanted circulation load, whereafter the process continues so that as much material is removed from it as ready product is added to it.

2. A method according to claim 1 characterized in that the pulp density of solids collected into intermediate tank is raised by means of a pressing screw conveyor before returning the solids to counterjet pulverizer.

3. A method according to claim 1 characterized in that material to be pulverized is fed to counterjet pulverizer through double-valve feeder and balancing tank, whereby in double-valve feeder a feed pressure higher than the regular feed pressure is used and the flow of counterjet pulverizer working gas is broken or choked for a while, when the lower valve of double-valve feeder is opened.

4. A method according to claim 3 characterized in that pulverizing is carried out at least in two counterjet pulverizers, whereby there is in one of them conventional acceleration nozzles and in the other acceleration nozzles furnished with gas outlet channels for effective pulverizing of high dispersed material.

5. A method according to claim 4 characterized in that for pressurizing and feeding of material to be pulverized two double-valve feeders side by side are used, which are synchronized so that the after-pressure left after release of material in one of the double-valve feeders can be utilized as initial pressure of the other double-valve feeder after receipt of new material.

6. A method according to any above claim characterized in that the end product removed from intermediate tank is conveyed to separate mechanical classifier outside the pulverizing circulation circle, where the greatest particles are separated from the end product and returned to intermediate tank for an additional pulverizing circulation.

7. A method according to claim 1 characterized in that in order to ensure the uniformity of the end product quality there is in the equipment a control unit, into which the limit values of the most important parameters of the pulverizing process, as the quantity of raw material, volume, pressure and temperature, of working gas, quantity of energy used for working gas pressurization and quantity of the circulation load are programmed.

8. A method according to claim 1 characterized in that the pulverizing conditions are regulated so that there is in the end product a portion of particles aimed at in granular class 0.2-5 μm.

9. A method according to claim 8 characterized in that in the project the material to be pulverized is circulated 2-10 times, advantageously 4-7, in order to achieve the set granular class.

10. A method according to claim 6 characterized in that the coarse product separated by classifier is returned to intermediate tank as pneumatical transfer from intermediate tank of the double-valve feeder after initial pressurizing by means of release gas.

11. A method according to claim 1 characterized in that material pre-pulverized by a mechanical pulverizer is used as raw material.
